(19) United States
(12) Patent Application Publication
(10) Pub. No.: US 2019/0332642 A1
(43) Pub. Date: Oct. 31, 2019

(54) System and Method for Computing Oscillating Functions

(71) Applicant: SiliconIntervention Inc., Kelowna (CA)

(72) Inventors: Christian Leth Petersen, Burnaby (CA); A. Martin Mallinson, Kelowna (CA)

(21) Appl. No.: 16/393,413

(22) Filed: Apr. 24, 2019

Related U.S. Application Data
(60) Provisional application No. 62/662,542, filed on Apr. 25, 2018.

(51) Int. Cl. G06F 17/14

(52) U.S. Cl. CPC G06F 17/141; G06F 17/142

(57) ABSTRACT

An improved system and method for quickly calculating Fourier transforms without multiplication is disclosed. A combinatorial unit circuit that contains only adders and scaling elements is used to calculate each sine wave value that is summed to create the Fourier transform. A real-time Fourier transform (RTFT) can be implemented using only a number of such combinatorial units, making it possible to complete a hardware DFT transform in a single clock cycle regardless of the number of samples of the input signal, thus bringing a significant improvement in speed and simplicity over the prior art. By using a chain of such combinatorial units and a sufficiently fast adder/multiplexor, a RTFT may be performed on an input signal in each frequency band and the outputs added to generate a transformed output signal in real-time for transmission of a signal. The input signal is recovered from the transmitted signal by the same process.

This application claims priority to Provisional Application No. 62/662,542, filed Apr. 25, 2018, which is incorporated by reference herein in its entirety.

### FIELD OF THE INVENTION

The present invention relates generally to the calculation of Fourier transforms and more specifically to a system and method for quickly calculating Fourier transforms without multiplication.

### BACKGROUND OF THE INVENTION

The discrete Fourier transform (DFT) converts a finite sequence of equally-spaced samples of a function into a same-length sequence of equally-spaced samples of the discrete-time Fourier transform (DTFT), which is a complex-valued function of frequency. The DFT has widespread use in many areas of science and engineering, including biomedical engineering, telecommunications and astronomy.

Oscillating functions in the form of a scalar multiplied by a complex exponential are an essential building block in computational mathematics, and particularly in the DFT. Such functions take the form:

ƒ(t)=Ae^{iωt} (Equation 1)

The DFT takes the form:

$$DFT ( k ) = {\sum }_{n = 0}^{N - 1} x ( n ) {e}^{\frac{2 π ink}{N}} \qquad ( Equation 2 )$$

where N is the number of samples. Direct calculation of the DFT according to Equation 2 can be difficult, as it involves O(N²) (order of N²) multiplications, and thus becomes prohibitively complex and time consuming for large values of N.

As is known in the art, one known technique to mitigate this difficulty is the algorithm to reduce the complexity of the DFT calculations that is known as the fast Fourier transform (FFT). The FFT factors the DFT matrix into a product of sparse (mostly zero) factors, and uses recursive application of a “butterfly” unit to combine the results of smaller transforms into a larger transform. The FFT can reduce the multiplicative complexity of the transform from O(N²) to O(N log(N)), a substantial improvement over the direct DFT calculation. While the difference in speed can be great, particularly when N is in the thousands or millions, the FFT may remain computationally demanding, often still involving hundreds or thousands of multiplications.

Further, the FFT does not address the need for generating the roots of unity in Equation 2; the roots of unity are used to implement the angular rotation of the transform and give rise to the bulk of the complexity in the conventional implementation of the FFT due to the need for complex multiplications between these numbers and the input samples. This requires tabulated storage of these so-called “twiddle factors” in Read-Only Memory (ROM). As a consequence, microelectronic implementations of the FFT require many clock cycles to complete a single transform and occupy a large chip area.

To avoid these issues, it would be useful to be able to calculate Fourier transforms quickly and without the need to perform complex multiplications.

### SUMMARY OF THE INVENTION

An improved system and method for quickly calculating Fourier transforms without multiplication is disclosed.

One embodiment discloses a circuit for calculating a quadrature output having X and Y values from a quadrature input having X and Y values which define a point on a sinusoidal waveform, comprising: a first scaling element configured to receive the input Y value and scale the input Y value by a scaling factor; a first adder configured to receive and add the input X value and the scaled Y value thereby producing the output X value; a second scaling element configured to receive the output X value and scale the output X value by the scaling factor; and a second adder configured to receive and add the input Y value and the scaled output X value thereby producing the output Y value; wherein the output X value and output Y value define a next point on the sinusoidal waveform.

Another embodiment discloses a circuit for performing a Fourier transform on samples of a signal, comprising: a chain of N combinatorial units, where N is a number of samples of a sine wave to be included in the Fourier transform, each combinatorial unit comprising: a first scaling element configured to receive an input Y value and scaling the Y value by a scaling factor; a first adder configured to receive and add an input X value and the scaled Y value thereby producing an output X value; a second scaling element configured to receive the output X value and scale the X value by the scaling factor; and a second adder configured to receive and add the input Y value and the scaled output X value thereby producing an output Y value; a first combinatorial unit in the chain receiving an input signal, and each subsequent combinatorial unit receiving as its input the output X and Y values of an immediately preceding combinatorial unit in the chain; a stateful adder configured to add selected combinations of outputs from the combinatorial units thereby determining a current transform element and add the current transform element to a prior transform sum to determine a current transform sum; and an output element configured to store the current transform sum and output the current transform sum after the series of quadrature inputs is complete.

Still another embodiment discloses a method for performing a Fourier transform on a signal, comprising: receiving by a circuit a series of quadrature inputs representing an input signal, each quadrature input having X and Y values; for each quadrature input, creating by the circuit a plurality of samples of a sine wave to be included in the Fourier transform by repeatedly: scaling by the circuit an input Y value by a scaling factor; adding by the circuit an input X value and the scaled Y value thereby producing an output X value; scaling by the circuit the output X value by the scaling factor; and adding by the circuit the input Y value and the scaled output X value thereby producing an output Y value; for each quadrature input, adding by the circuit selected combinations of sine wave samples thereby determining a current transform element; and adding by the circuit all of the current transform elements from each quadrature input.

Yet another embodiment discloses a method for calculating a quadrature output having X and Y values from a quadrature input having X and Y values which define a point on a sinusoidal waveform, comprising: scaling by the circuit the input Y value by a scaling factor; adding by the circuit the input X value and the scaled Y value thereby producing an output X value; scaling by the circuit the output X value by the scaling factor; and adding by the circuit the input Y value and the scaled output X value thereby producing an output Y value; wherein the output X value and output Y value define a next point on the sinusoidal waveform.

Another embodiment discloses a circuit for performing a discrete Fourier transform on four samples of a signal, comprising: first and second arithmetic units each configured to receive a different two of the samples as complex quadrature inputs having X and Y values, and each comprising first and second complex adders, the first complex adder adding the input X and Y values of the two samples, and the second complex adder adding the X and Y value of one sample to the inverse of the X and Y values of the other sample, thereby resulting in two quadrature outputs having X and Y components; first, second, third and fourth combinatorial units, each combinatorial unit comprising: a first scaling element configured to receive an input Y value and scaling the Y value by a scaling factor; a first adder configured to receive and add an input X value and the scaled Y value thereby producing an output X value; a second scaling element configured to receive the output X value and scale the X value by the scaling factor; and a second adder configured to receive and add the input Y value and the scaled output X value thereby producing an output Y value; the first and third combinatorial units configured to receive a first quadrature output of the first arithmetic unit, and the second and fourth combinatorial unit configured to receive a second quadrature of the first FFT unit; first, second, third and fourth adders; the first adder configured to add the first output of the second arithmetic unit to the output of the first combinatorial unit; the second adder configured to add the second output of the second arithmetic unit to the output of the second combinatorial unit; the third adder configured to add the first output of the second arithmetic unit to the output of the third combinatorial unit; and the fourth adder configured to add the Y output of the second arithmetic unit to the output of the fourth combinatorial unit.

### BRIEF DESCRIPTION OF THE DRAWINGS

FIG. 1 is a block diagram of a combinatorial circuit for calculating a rotated input element to be used in a Fourier transform according to one embodiment.

FIG. 2 is a block diagram of a circuit for calculating an output element of a Fourier transform according to one embodiment.

FIG. 3 is a circuit diagram of an analog combinatorial circuit for calculating an input element to be used in a Fourier transform according to one embodiment.

FIG. 4 is a circuit diagram of a first portion of an analog circuit for calculating an output element of a Fourier transform according to one embodiment.

FIG. 5 is a block diagram of a circuit 500 for performing a Fourier transform on a streaming signal according to one embodiment.

FIG. 6 is a block diagram of a circuit 600 for receiving a streaming signal that has undergone a Fourier transform according to one embodiment.

FIG. 7 is a circuit diagram of a combinatorial circuit for calculating an input element to be used in a Fourier transform according to another embodiment.

FIGS. 8 and 9 are block diagrams of circuits 800 and 900 for performing a FFT according to the Cooley-Tukey algorithm in one embodiment.

FIG. 10 is a flowchart of a method of performing a Fourier transform according to one embodiment.

### DETAILED DESCRIPTION OF THE INVENTION

An improved system and method is provided for calculating Fourier transforms using only combinatorial elements, thus completely eliminating the need for multiplication. A combinatorial unit circuit that contains only adders and scaling elements is used to calculate each value, as in Equation 1 above, that is then summed to create the Fourier transform as in Equation 2 above.

In various embodiments, the system and method utilize the fact that a real-time Fourier transform (RTFT) that includes all the multiplications and roots of unity in Equation 2 can be implemented through only a number of such combinatorial units, making it possible to complete a hardware DFT transform in a single clock cycle regardless of the value of N, and eliminating the need for a twiddle factor ROM used in the FFT. This brings a significant improvement in speed and simplicity over the prior art.

It is known that the exponential value in Equation 1 can be written as:

e^{iωt}=cos ωt+i sin ωt (Equation 3)

which describes a circle in a plane having a real axis and an orthogonal imaginary axis.

In 1972, Marvin Minsky of MIT, in an exploration of early computer graphics, noticed that a simple algorithm of the form:

X₁=X₀−εY₀

Y₁=Y₀−εX₁ (Equation 4)

produces a sequence of points (X,Y) that also forms a circle, Minsky M, MIT AI Memo 239, item 149, February 1972, and thus also a sine wave. The circles were noted to be imperfect, and the algorithm was thus not pursued in the computer graphics field. Despite the perceived imperfection, the circular response of Equation 4 is similar enough to that of Equation 1 (or the equivalent Equation 3) so as to represent a remarkably simple approach to generating a quadrature harmonic oscillation.

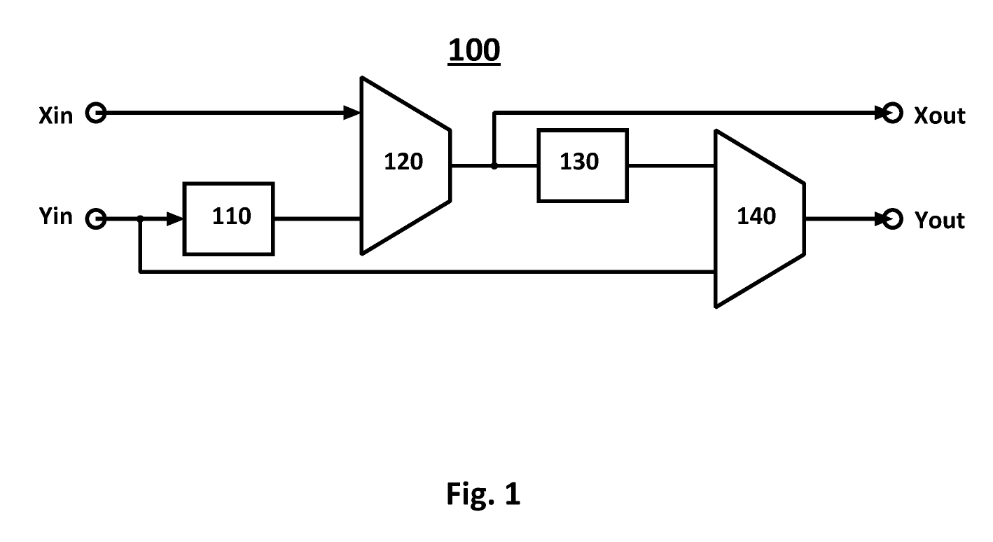

In fact, the imperfection of Equation 4 is due to a phase shift of half a step, and thus Equation 4 can be made to produce a mathematically perfect quadrature oscillator, in effect generating a sequence of roots of unity with every iteration or step. Further, although presented as a sequence of two assignments as in Equation 4, the algorithm has no state. This is essential to its function, as introducing a temporary state will cause the algorithm to diverge. This lack of state allows the algorithm to be represented as a unit of combinatorial logic, shown in FIG. 1.

FIG. 1 is a block diagram of a combinatorial circuit 100 that performs the calculation of Equation 4 to calculate one input element of a Fourier transform. Circuit 100 receives a quadrature input (Xin,Yin). The value of Yin is scaled by a scaling element 110 and the scaled value of Yin is added to Xin in adder, or summing element, 120, resulting in a new X value Xout. The new value Xout is then scaled by scaling element 130, and the scaled value of Xout is added to Yin in adder, or summing element, 140, resulting in a new Y value Yout. If scaling units 110 and 130 respectively scale the X and Y values by E, circuit 100 thus performs the calculation of Equation 4 on an quadrature input (Xin,Yin), resulting in an output (Xout,Yout).

Any method or circuit known in the art can be used to implement scaling elements 110 and 130 and adders 120 and 140. In one embodiment the scaling elements are implemented as bit shifts, allowing data to flow through circuit 100 without the need of a clock, resulting in a near-immediate quadrature output (X′,Y′).

If the initial values X₀ and Y₀ are 1 and 0, respectively, Equation 4 will produce the values of a sine wave with an amplitude of 1. By changing the initial value of X to be an actual input value, Equation 4 results in the values of a sine wave that varies in amplitude based upon the initial value of X. (The initial value of Y typically remains 0, except in the case of a complex DFT.) Thus, each sample results in a string of all of the phase shifted values of the value of X as if the value of X has been multiplied by all of the points on a sine wave. These points are then summed in appropriate combinations to get the Fourier transform of X.

Multiple instances of combinatorial circuit 100 can thus be used to obtain all of the values of Equation 4, and thus of Equation 1, for a given input value X. These values can then be added in the desired combinations, as in Equation 2, to obtain the Fourier transform of X. In one embodiment, this allows all of the multiplications and unity roots of the DFT to be implemented instead in a purely combinatorial fashion as a simple chain of such circuits.

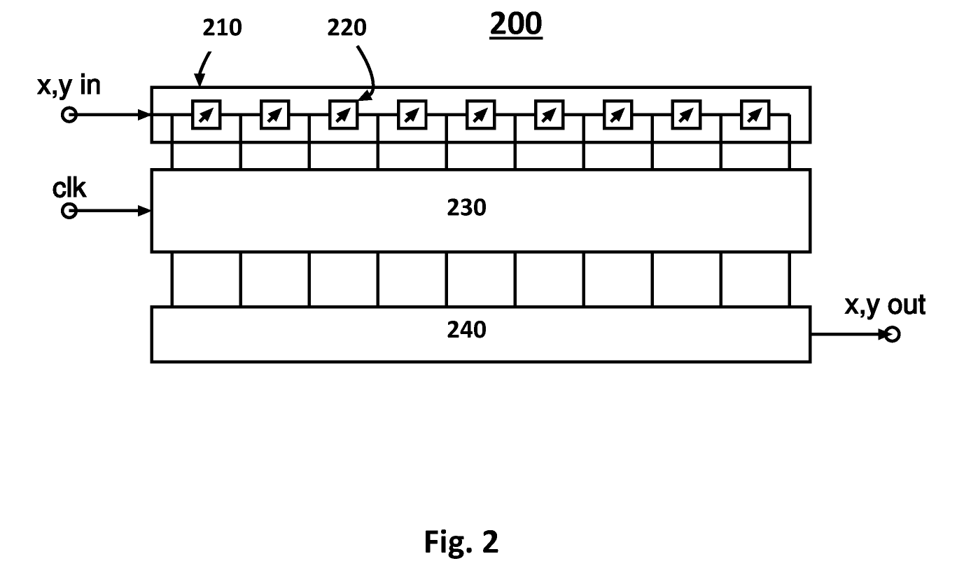

FIG. 2 is a block diagram of one embodiment of a circuit 200 for calculating an output element of a Fourier transform with a combinatorial circuit using multiple instances of the circuit 100 of FIG. 1. Circuit 200 includes a chain 210 of N combinatorial circuits 220, where N as above is the number of samples of one rotation of a sine wave effectively multiplied by the value of an input X by combinatorial circuits 220; each combinatorial circuit 220 is an instance of circuit 100 of FIG. 1, and the output of each such combinatorial circuit 220 becomes the input to the next combinatorial circuit 220 in chain 210. A quadrature input (X,Y) enters chain 210 of combinatorial circuits 220 on a clock cycle, and flows through the chain immediately, thus resulting in a concurrent set of oscillating function values.

The function values from combinatorial circuits 220 are input to an adder 230, which adds selected values from the combinatorial circuits 220 to a sum stored in output element 240 so as to incrementally determine the DFT sum according to Equation 2 above; adder 230 may be considered a “stateful” adder in that it adds each received sum to the prior total stored in output element 240, which accumulates the final result over all of the input samples.

The stateful adder implements a sum of selected values from the combinatorial circuits 220 with a rolling “stride”, skipping over values with a step that is defined by the input sample position according to Equation 2. One of skill in the art will be able to determine the logic appropriate for stateful adder 230 to add the desired values to obtain each value to be added to the DFT sum. Output element 240 may be double buffered, so that when the last input value has been clocked in and the DFT calculation is complete, the transform result can be output on a clock cycle while a new input block is being input and processed on the same clock cycle.

Circuit 200 thus implements a fully streaming, multiplier-free DFT; the circuit 200 has zero latency beyond the time it takes to clock data into the chain 210 of combinatorial units 220. Circuit 200 can be implemented with a total of 3N adders, and no multipliers; as above, each of the N combinatorial units 220 has two adders, while stateful adder 230 has N individual adders, one for each of the N values to be added to calculate the transform according to Equation 2 (each of the adders in stateful adder 230 will have multiple inputs). Stateful adder 230 will also have the logic needed to determine which samples are to be added together as in Equation 2.

In some embodiments, adder 230 will have an equal number of input and output ports, while in other embodiments adder 230 will perform interpolation between the harmonic function elements in order to generate a smaller desired final transform size and/or improve noise.

The circuits 100 and 200 of FIGS. 1 and 2 respectively can be implemented in either digital or analog form. If the circuits 100 and 200 use digital components, the inputs will be digital multi-bit signals, while if the components are analog the input will be a single continuous signal value.

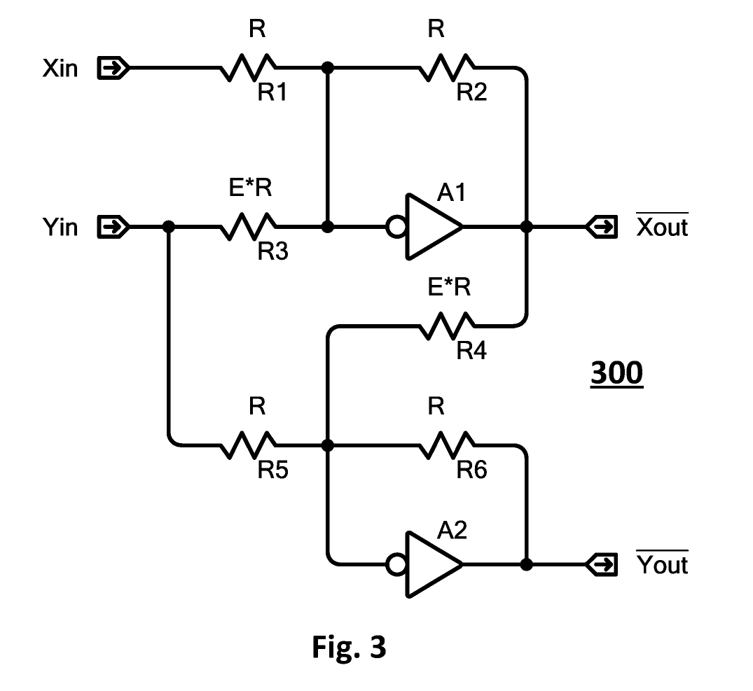

It will be obvious to those of skill in the art how to implement circuits 100 and 200 in digital form. FIG. 3 is a circuit diagram of an analog combinatorial circuit 300 for calculating an input element to be used in a Fourier transform according to one embodiment.

Circuit 300 calculates new values of Xout and Yout from quadrature input Xin and Yin according to Equation 4 above (with one exception noted below). The resistance of resistors R3 and R4 is greater than that of the other resistors by the factor E, thus providing the scaling factor of Equation 4.

Amplifiers A1 and A2 in circuit 300 have a high open loop gain and amplify their input by a large negative number, so that the output may, for example, be characterized as:

AmpOut=−1e⁶·AmpIn (Equation 5)

Note that circuit 300 thus results in the values of Xout and Yout being the inverse of the values predicted by Equation 4 above. This must be taken into account when constructing a chain of such analog combinatorial circuits.

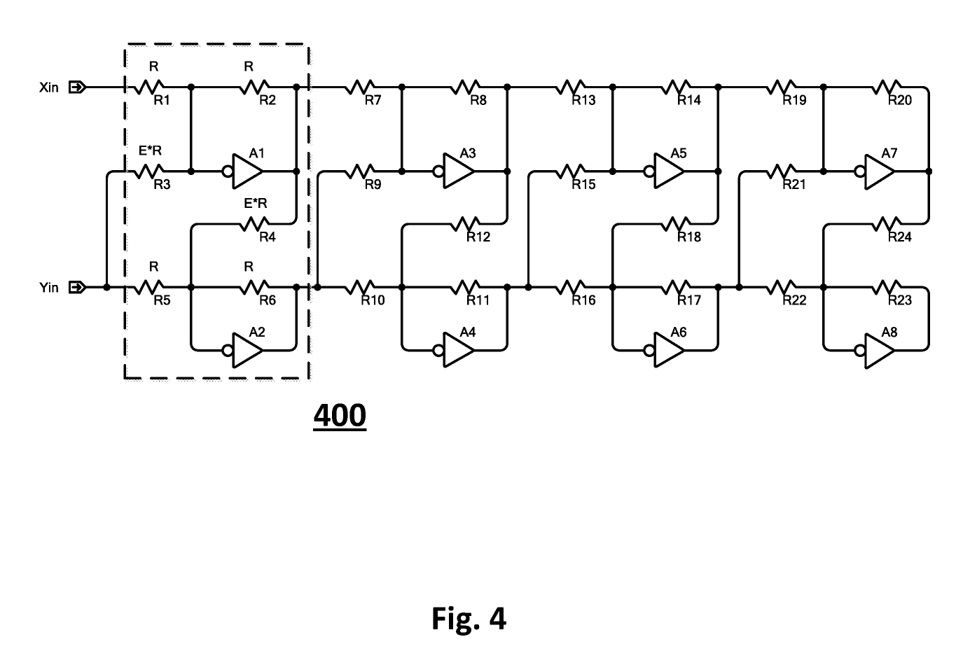

FIG. 4 is a circuit diagram of a first portion of analog circuit 400 for calculating an output element of a Fourier transform according to one embodiment, using a chain of combinatorial circuits of the form of circuit 300. In FIG. 4, the chain contains four circuits of the form of circuit 300; the first such instance, contained in the dashed lines, uses the same reference numbers for resistors R1 to R6 and amplifier A1 and A2 as in FIG. 3, while the later instances use different reference numbers.

As in FIG. 2, the output of each combinatorial circuit becomes the input to the next combinatorial circuit, so that a sequence of values is generated along the sequence of combinatorial circuits that represents a sine wave having the amplitude of the input value of Xin. Thus, the outputs of Amplifiers A1, A3, A5, A7 etc., provide the sequence of X values, while the outputs of Amplifiers A2, A4, A6, A8 etc., provide the sequence of Y values.

As above, the output of each combinatorial circuit of the form of circuit 300 inverts from the sign of the input. In practice this is easily handled; for example, if a circuit of the form of circuit 400 is used as the chain 210 of combinatorial circuits 220 in FIG. 2, stateful adder 230 will be configured to invert every other output of a combinatorial circuit so as to obtain the proper inputs to the Fourier transform summation of Equation 2.

As will be clear to one of skill in the art, in some embodiments, the symmetry of the unit circle can be exploited to reduce the number of combinatorial circuits in a chain from the number needed to cover a full cycle of a sine wave, and instead, by applying the symmetry of the sine wave, use only the number of elements sufficient to cover one quarter of the full sine wave cycle. Further, some units may be operated in reverse, allowing a chain length of only ⅛^{th} of the full sine wave cycle. This may prevent timing issues from arising as data flows through the combinatorial units at high values of N.

The system and method described herein can also provide improvements in streaming applications. When a conventional DFT is applied to a stream of data, the block nature of the transform generates artifacts in the form of spectral bleed in the transform output, known as “windowing.” This is undesirable, particularly in telecommunication applications, where it can degrade the bandwidth of a transmission relying on the DFT, such as in orthogonal frequency-division multiplexing (OFDM). It is possible to avoid these artifacts with another embodiment of the present system and method.

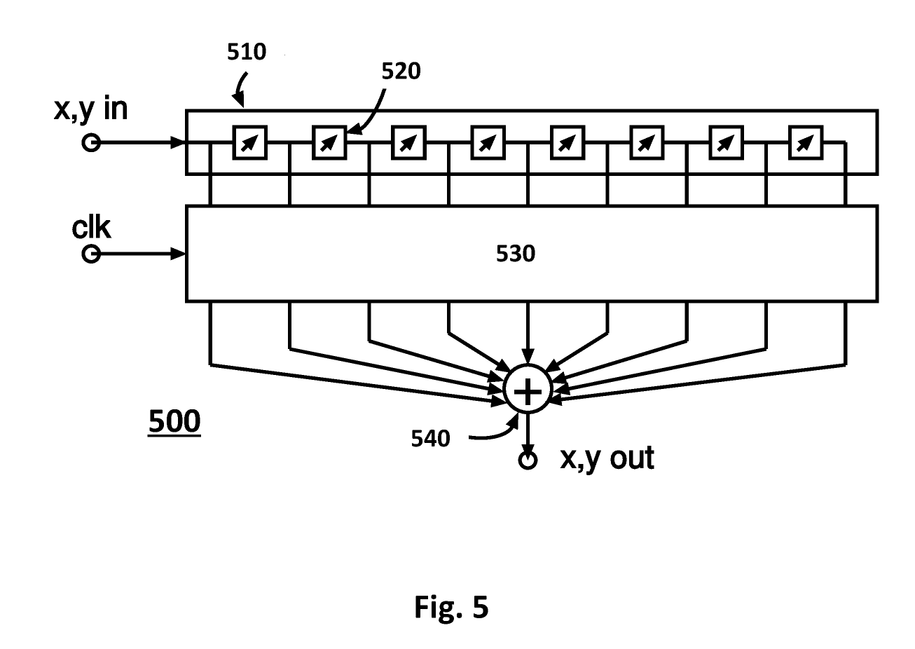

FIG. 5 is a block diagram of a circuit 500 for performing a real-time Fourier transform on a streaming signal such as might be used in a transmitter. As in circuit 200 of FIG. 2, a quadrature signal (X,Y) enters a combinatorial chain 510 of N combinatorial circuits 520 that multiplies the input signal by a sine wave frequency, and flows through the chain to provide a concurrent set of sine wave values. The X value of the quadrature input is the signal sample to be transformed; the Y value of the quadrature input is zero. However, a streaming signal, such as that to be transmitted, will typically have multiple bands or channels.

While in circuit 200 one set of samples is clocked in on each clock cycle to determine one element of a Fourier transform, circuit 500 must operate faster due to the need for an output signal for each band, or frequency, of the input signal. One set of samples for each band must be processed in order to generate a single output sample; the sets of samples are taken in to circuit 500 serially.

This may be accomplished either by operating circuit 500 at a faster rate, or by providing more than one instance of circuit 500 operating in parallel. Thus, if the input signal to circuit 500 has, for example, 32 bands, and only a single circuit 500 is used, the clock for adder/multiplexor 530 must run at 32 times the speed of the system that generates the input signal.

The sine wave values from combinatorial circuits 520 are input to N-to-M adder/multiplexer 530 that in turn outputs a series of sine wave functions of different frequency generated by variation in stride as the multiplexer selects different combinations of values from the combinatorial chain on every clock. The resulting signals are input to adder 540, to output a sum of modulated quadrature waveforms. The samples for one band of the input signal are processed on each clock cycle, and one output sample is thus created every 32 clock cycles.

The need for a faster clock speed may be significant. For example, WiFi applications typically have 64 bands and operate at a 50 megahertz (MHz) base band before modulation. Thus, the clock in a single circuit 500 for such an application would need to run at 50×64=3200 MHz, or 3.2 gigahertz (GHz). The required clock speed will obviously be reduced if multiple circuits 500 are used in parallel, but at the cost of additional area occupied (on a chip, for example) by each such parallel circuit. It is possible to even place 32 such circuits in parallel, each operating at the same speed as the system generating the input signal, but with a needed area 32 times as large as a single circuit.

The output of circuit 500 provides a continuous Fourier transform which can then be modulated for a carrier wave (not shown), and is truly streaming without the windowing artifacts present in the conventional DFT. The latency is zero, as a new valid sample is generated immediately upon every new input. This can benefit transmitter implementations in telecommunications by reducing noise and maximizing speed and bandwidth, and it only requires 2N addition operations to implement, requiring far less computation than the traditional DFT equivalent embodiment.

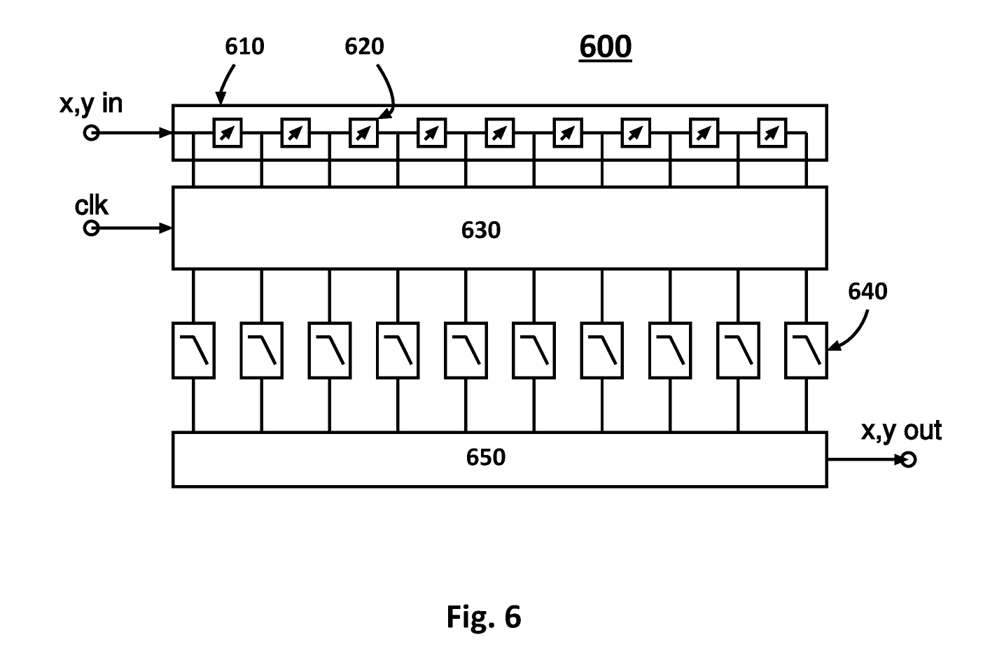

FIG. 6 is a block diagram of a circuit 600 for receiving a streaming signal that has undergone a Fourier transform according to one embodiment. Circuit 600 might be used as the receiver of a streaming signal corresponding to the transmitter circuit 500 of FIG. 5, and performs the reverse of the operation of circuit 500 to reconstruct the input signal of circuit 500.

Again, a quadrature signal (X,Y), which is the received signal (after the carrier wave is demodulated down to the base band, not shown), enters a chain 610 of combinatorial units 620 as with the circuits above. The combinatorial circuits 620 demodulate the received signal by a frequency in the same way that combinatorial circuits 520 modulated the input signal in circuit 500; just as the input signal to circuit 500 had to be modulated for each frequency band, the received signal in circuit 600 must be demodulated by each frequency.

Thus, as with circuit 500, if only a single instance of circuit 600 is used, it again must be operated at a speed faster than that of the underlying signal generation system, as now a single input quadrature signal must be used to generate all of the bands of the original signal input into circuit 500. Alternatively, as above, multiple instances of circuit 600 may be used, decreasing the required speed of each circuit but increasing the size of the overall circuit.

The resulting signals from combinatorial units 620 are input to N-to-M multiplexer 630 to combine the different demodulated frequency components of the received signal, each frequency entering one of low pass filters 640 to add a frequency component to the reconstructed original signal in double buffer adder 650, from which the output is generated at the same rate as the input to the original signal-generating system.

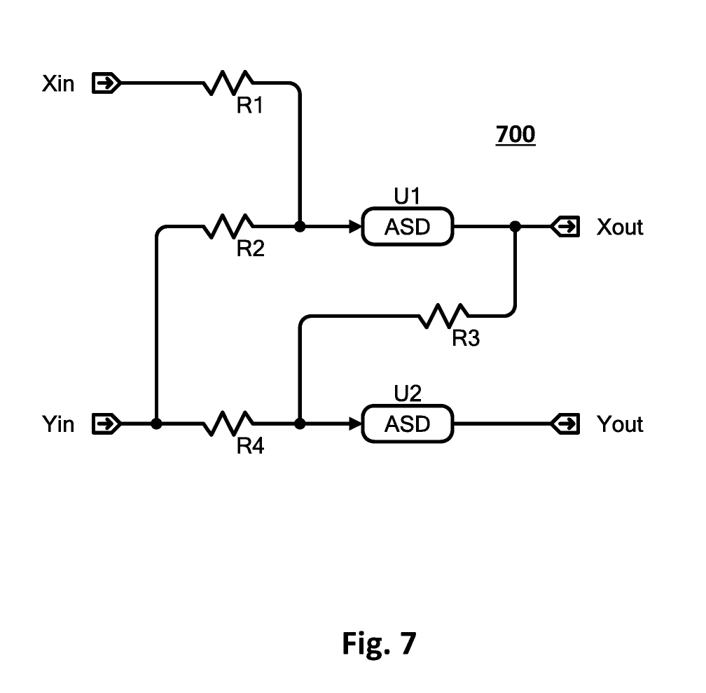

One of skill in the art will appreciate that many different processing elements can be configured to implement the rotation of signals represented as complex pairs as described herein. FIG. 7 here shows another example, in which single-bit sigma delta modulators with analog input and digital output (ASDs), as known in the art, are used in the rotation circuit. The inputs and outputs are now single bit streams of data, conceptually +1 and −1. Weighted summations of the average value of the bit streams are formed with different resistor values analogous to the analog example of circuit 300 in FIG. 3.

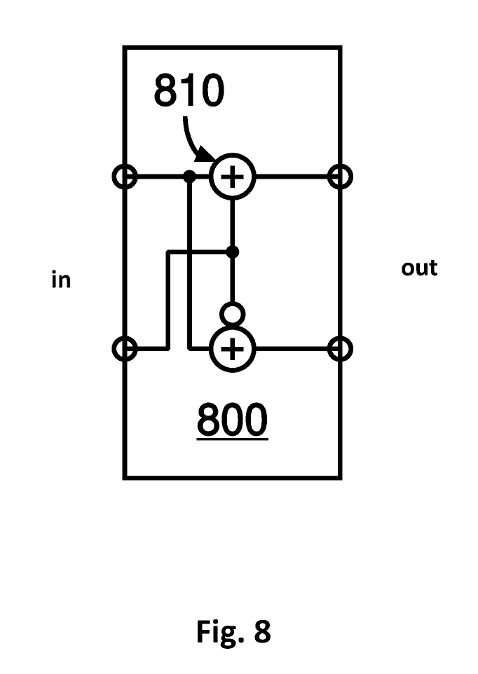

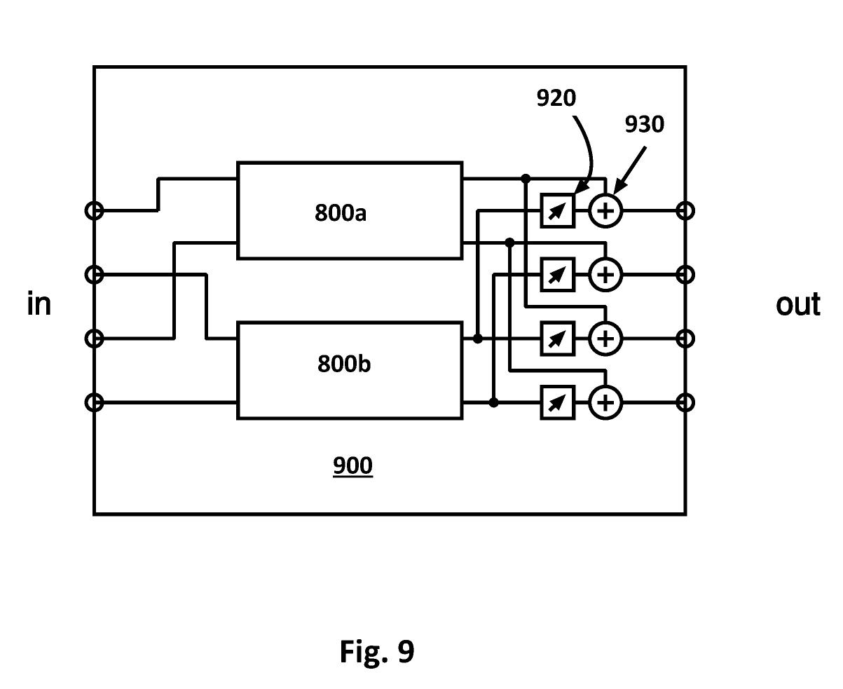

Circuits such as circuit 100 of FIG. 1 and the alternatives of FIG. 3 and FIG. 7 may also be used to help in the application of the FFT algorithm, as shown in FIGS. 8 and 9.

FIGS. 8 and 9 are block diagrams of circuits 800 and 900 for performing a FFT according to the Cooley-Tukey algorithm in one embodiment. The Cooley-Tukey algorithm is commonly used, and breaks a DFT, here of N=4, into two smaller FFT's, here of N=2 each.

In order to start the method of Cooley-Tukey, in circuit 800 of FIG. 8 two quadrature inputs are combined by two complex adders 810 to generate two quadrature outputs; one of the complex adders 810 implements a sign change as indicated on the lower complex adder 810 in FIG. 8. As is known in the art, each input and output is a two-wire bus representing a complex number.

FIG. 900 is a block diagram of a circuit 900 that provides one step in the Cooley-Tukey algorithm. Circuit 900 receives four quadrature inputs that are to be used to obtain a FFT, and produces four quadrature outputs. Elements 800a and 800b are instances of circuit 800 of FIG. 8, each receiving two of the quadrature inputs and providing two quadrature outputs as above.

The outputs of elements 800a and 800b are as shown in FIG. 8, and are provided to combinatorial units 920 as shown; each combinatorial unit 920 is, for example, circuit 100 of FIG. 1, circuit 300 of FIG. 3 or circuit 700 of FIG. 7, which rotate the signals as described above; in this example, the four combinatorial circuits 920 rotate their inputs by 0, 90, 180 and 270 degrees, respectively. The outputs of circuits 800a and 800b and combinatorial units 920 are added by complex adders 930 to obtain four quadrature outputs. If there is no further processing, circuit 900 results in a FFT in which N=4.

As is well known in the art, this concept can be applied recursively to create FFTs of larger sizes. Thus, the outputs of circuit 900 may be applied to two more instances of a circuit of configuration similar to circuit 900, but in which circuits 800a and 800b are replaced by instances of circuit 900 itself, and the rotations produced by combinatorial units 920 now result in eight rotations, i.e., every 45 degrees. This may be followed by four more such circuits to obtain 16 equally spaced rotations, etc., each circuit using the prior circuit in place of circuits 800a and 800b. In this way a circuit capable of performing a FFT of any desired size of N may be constructed.

The benefit of using the circuit 100 from FIG. 1 in the Cooley-Tukey algorithm is that all the complex multiplications with roots of unity are eliminated and the entire FFT can be implemented as a single combinatorial flow that has no state and no latency other than the timing delay intrinsic to the circuit elements themselves.

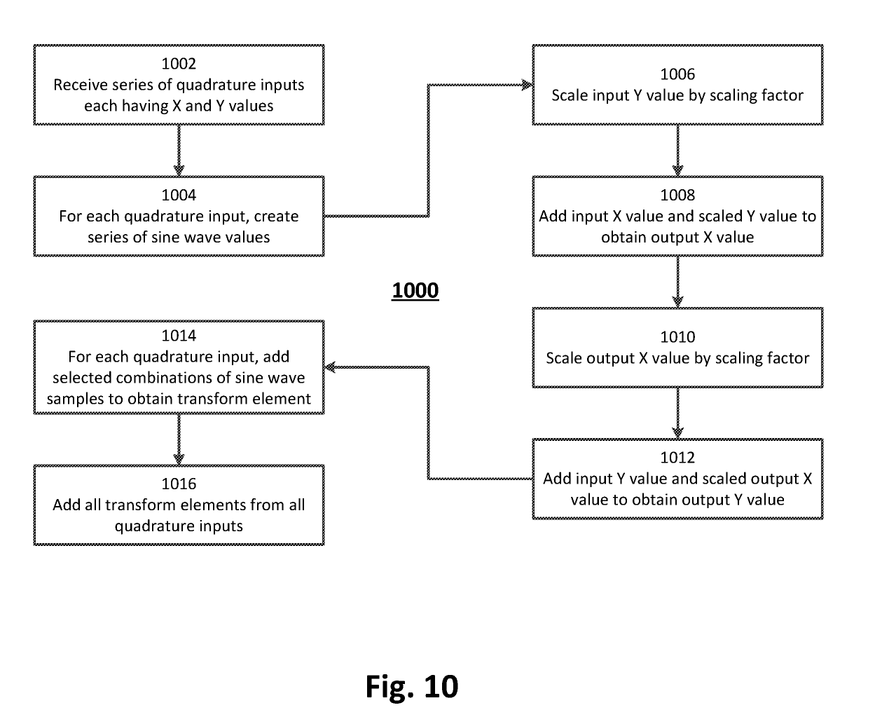

FIG. 10 is a flowchart of a method of performing a Fourier transform according to one embodiment. This is done by a circuit, for example, circuit 200 of FIG. 2, circuit 400 of FIG. 4 or circuit 500 of FIG. 5. At step 1002, the circuit receives a series of quadrature inputs each having X and Y values.

At step 1004, a series of sine wave values is created for each quadrature input. This is done sequentially, i.e., the sine wave samples are created for the first quadrature input, then the second quadrature input after the first quadrature input has been transformed as below, etc.

In steps 1006 to 1012, the sine wave samples are created according to Equation 4 above, for example, by combinatorial units such as circuit 100 of FIG. 1. At step 1006 the input Y value is scaled by a scaling factor, and at step 1008 the input X value and the scaled Y value are added to obtain an output X value.

At step 1010, the output X value is scaled by the scaling factor, and at step 1012 the input Y value and the scaled output X value are added to obtain an output Y value.

At step 1014, selected combinations of the sine wave values of the quadrature input are added to obtain a transform element of the Fourier transform, for example, by stateful adder 230 of FIG. 2 or N-to-M multiplexor 530 of FIG. 5.

At step 1016, all of the transform elements from all of the quadrature inputs are added to obtain the Fourier transform of the quadrature input series.

It will be apparent that steps 1006 to 1012 comprise a method corresponding to circuit 100 of FIG. 1, i.e., calculating a rotated input element to be used in a Fourier transform.

In another embodiment the system and method described herein can be used to compute the Discrete Cosine Transform (DCT). The DCT has important applications in image, audio and video compression and is widely used in lossy compression encoders such as MPEG and JPEG. The N-point DCT can be obtained by performing a 4N- or 2N-point RTFT on a zero-padded or mirrored input vector, according to any of the known methods in the art for deriving the DCT from the DFT. The technique described herein provides one means to perform zero-latency compression for high speed real-time applications.

In still a further embodiment the described system and method can be used for finite Fourier series approximations of periodic functions such as sawtooth and triangle waveforms, by realizing fixed combinations of oscillating function terms with combinatorial logic. This provides new ways to efficiently generate complex waveforms for signal processing applications.

It should be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc. It may be possible to incorporate some methods into hard-wired logic if desired. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A circuit for calculating a quadrature output having X and Y values from a quadrature input having X and Y values which define a point on a sinusoidal waveform, comprising:
a first scaling element configured to receive the input Y value and scale the input Y value by a scaling factor;
a first adder configured to receive and add the input X value and the scaled Y value thereby producing the output X value;
a second scaling element configured to receive the output X value and scale the output X value by the scaling factor; and
a second adder configured to receive and add the input Y value and the scaled output X value thereby producing the output Y value;
wherein the output X value and output Y value define a next point on the sinusoidal waveform.

2. The circuit of claim 1 wherein the first and second scaling elements and first and second adders are comprised of analog components.

3. The circuit of claim 1 wherein the first and second scaling elements and first and second adders are comprised of digital components.

4. The circuit of claim 1 wherein the first and second adders comprise single-bit sigma delta modulators with analog input and digital output.

5. The circuit of claim 1 wherein the quadrature input is a digital multi-bit signal.

6. The circuit of claim 1 wherein the quadrature input is a single continuous analog value.

7. A circuit for performing a Fourier transform on samples of a signal, comprising:
a chain of N combinatorial units, where N is a number of samples of a sine wave to be included in the Fourier transform, each combinatorial unit comprising:
a first scaling element configured to receive an input Y value and scaling the Y value by a scaling factor;
a first adder configured to receive and add an input X value and the scaled Y value thereby producing an output X value;
a second scaling element configured to receive the output X value and scale the X value by the scaling factor; and
a second adder configured to receive and add the input Y value and the scaled output X value thereby producing an output Y value;
a first combinatorial unit in the chain receiving an input signal, and each subsequent combinatorial unit receiving as its input the output X and Y values of an immediately preceding combinatorial unit in the chain;
a stateful adder configured to add selected combinations of outputs from the combinatorial units thereby determining a current transform element and add the current transform element to a prior transform sum to determine a current transform sum; and
an output element configured to store the current transform sum and output the current transform sum after the series of quadrature inputs is complete.

8. The circuit of claim 7, wherein the output element is double buffered.

9. The circuit of claim 7 wherein the first and second scaling elements and first and second adders are comprised of analog components.

10. The circuit of claim 7 wherein the first and second scaling elements and first and second adders are comprised of digital components.

11. The circuit of claim 7 wherein the first and second adders comprise single-bit sigma delta modulators (ASD) with analog input and digital output.

12. The circuit of claim 7 wherein the quadrature input is a digital multi-bit signal.

13. The circuit of claim 7 wherein the quadrature input is a single continuous analog value.

14. A method for performing a Fourier transform on a signal, comprising:
receiving by a circuit a series of quadrature inputs representing an input signal, each quadrature input having X and Y values;
for each quadrature input, creating by the circuit a plurality of samples of a sine wave to be included in the Fourier transform by repeatedly:
scaling by the circuit an input Y value by a scaling factor;
adding by the circuit an input X value and the scaled Y value thereby producing an output X value;
scaling by the circuit the output X value by the scaling factor; and
adding by the circuit the input Y value and the scaled output X value thereby producing an output Y value;
for each quadrature input, adding by the circuit selected combinations of sine wave samples thereby determining a current transform element; and
adding by the circuit all of the current transform elements from each quadrature input.

15. The method of claim 14 wherein the quadrature inputs are each digital multi-bit signals.

16. The method of claim 14 wherein the quadrature inputs are each single continuous analog values.

17. A method for calculating a quadrature output having X and Y values from a quadrature input having X and Y values which define a point on a sinusoidal waveform, comprising:
scaling by the circuit the input Y value by a scaling factor;
adding by the circuit the input X value and the scaled Y value thereby producing an output X value;
scaling by the circuit the output X value by the scaling factor; and
adding by the circuit the input Y value and the scaled output X value thereby producing an output Y value;
wherein the output X value and output Y value define a next point on the sinusoidal waveform.

18. The method of claim 17, further comprising repeatedly performing by the circuit the steps of scaling and adding X and Y values, using the output X and Y values from each set of steps of scaling and adding as the input X and Y values to the next set of steps of scaling and adding X and Y values, thereby creating a plurality of samples of a sine wave to be included in the Fourier transform.

19. A circuit for performing a discrete Fourier transform on four samples of a signal, comprising:
first and second arithmetic units each configured to receive a different two of the samples as complex quadrature inputs having X and Y values, and each comprising first and second complex adders, the first complex adder adding the input X and Y values of the two samples, and the second complex adder adding the X and Y value of one sample to the inverse of the X and Y values of the other sample, thereby resulting in two quadrature outputs having X and Y components;
first, second, third and fourth combinatorial units, each combinatorial unit comprising:
a first scaling element configured to receive an input Y value and scaling the Y value by a scaling factor;
a first adder configured to receive and add an input X value and the scaled Y value thereby producing an output X value;
a second scaling element configured to receive the output X value and scale the X value by the scaling factor; and
a second adder configured to receive and add the input Y value and the scaled output X value thereby producing an output Y value;
the first and third combinatorial units configured to receive a first quadrature output of the first arithmetic unit, and the second and fourth combinatorial unit configured to receive a second quadrature of the first FFT unit;
first, second, third and fourth adders;
the first adder configured to add the first output of the second arithmetic unit to the output of the first combinatorial unit;
the second adder configured to add the second output of the second arithmetic unit to the output of the second combinatorial unit;
the third adder configured to add the first output of the second arithmetic unit to the output of the third combinatorial unit; and
the fourth adder configured to add the Y output of the second arithmetic unit to the output of the fourth combinatorial unit.
